(19) United States
(12) Patent Application Publication
(10) Pub. No.: US 2010/0180537 A1
(43) Pub. Date: Jul. 22, 2010

(54) Method for Protecting a Plant Structure Against Wind Damage

(76) Inventor: Richard J. Flaster, Cherry Hill, NJ (US)

Correspondence Address: FLASTER/GREENBERG P.C.;Four Penn Center, 1600 John F. Kennedy Boulevard, 2nd Floor, PHILADELPHIA, PA, 19103, US

(21) Appl. No.: 12/750,261

(22) Filed: Mar. 30, 2010

Related U.S. Application Data
(63) Continuation of application No. 11/999,940, filed on Dec. 7, 2007.
(60) Provisional application No. 60/873,828, filed on Dec. 8, 2006.

(51) Int. Cl. E04B 1/92; A01G 13/02

(52) U.S. Cl. 52/741.3; 47/32.3

(57) ABSTRACT

A method and device are described for protecting structures having a central longitudinal portion and radially extending arms, including plants such as palm trees from wind damage. The device may be positioned around a structure and includes a flexible material configured to wrap around a central longitudinal portion and radially extending arms, such that a lower edge of the flexible material is positioned near a lower portion of the radially extending arms and when wrapped around the structure, a portion of the radially extending arms is pushed toward the central longitudinal portion of the structure and two side edges of the flexible material are proximate one another. The device fastens around the structure and is configured to secure the radially extending arms against the central longitudinal portion of the structure and to reinforce the central longitudinal portion of the structure thereby protecting the structure against wind damage.

### CROSS-REFERENCE TO RELATED APPLICATIONS

This application claims the benefit under 35 U.S.C. §119(e) to U.S. Provisional Patent Application No. 60/873,828, filed Dec. 8, 2006, the entire disclosure of which is incorporated herein by reference.

### BACKGROUND OF THE INVENTION

1. Field of the Invention

This invention is in the field of a protection device, specifically a device for assisting in protecting plants, particularly palm trees and other similar trees and shrubs, as well as other similarly vulnerable items from wind, and for providing reinforcement.

2. Description of Related Art

Plants such as palm trees (i.e., trees of the Family Palmacae) and similar plants and shrubs grow their fronds (compound palmote leaves) from a single inner growth core. However, the growth core often breaks off in the face of high winds resulting in the death of the tree. Other plants and flexible structures of similar configuration are vulnerable to wind as well, including plants in which branches and stems rely on the strength of the trunk or plant base for support, certain umbrellas, bulky awnings, signs and the like.

Although inventions exist to reinforce such plants and structures, there is a need in the art for a device that is able to protect and reinforce such structures which is easy to use, lightweight and inexpensive, and a particular need in the art to protect the inner growth core of a palm tree (which is able to produce future fronds if the growth core survives) from being broken or snapped off by force of winds such as through strong wind storms, hurricanes and the like.

### BRIEF SUMMARY OF THE INVENTION

The invention includes a device for securing a structure, comprising a flexible material having a first surface and a second surface, wherein the first and the second surfaces have a common first edge, a second edge, a third edge and a fourth edge, each of the edges has a length measured along the largest dimension of the edge, the length of the first edge is greater than the length of the second edge, and the third and fourth edges extend between the first edge and the second edge; and a detachable fastening mechanism for fastening the device when the device is wrapped around a structure by bringing the third and fourth edges adjacent to one other, and wherein the flexible material is configured for wrapping around a structure and fastening in order to hold and reinforce the structure.

In one embodiment, the flexible material comprises canvas, a polymeric woven fabric, or a polymeric unwoven fabric.

Further, in yet another embodiment, the third edge and the fourth edge are substantially the same length and/or the first edge and the second edge may have a generally arcuate configuration, in which case when the device is wrapped around a structure it has a generally frustoconical configuration.

In a further embodiment, the fastening mechanism comprises a first Velcro strip positioned in a longitudinally extending direction along the first surface of the flexible material adjacent the third edge of the flexible material and at least one flexible strip secured to the first surface of the flexible material adjacent the fourth edge of the flexible material and extending outwardly in a transverse direction from the fourth edge of the flexible material, wherein the flexible strip has a second Velcro strip capable of mating with the first Velcro strip positioned on a first side of the flexible strip and facing in the direction of the second surface of the flexible material.

In a preferred embodiment, the structure is a plant, and more preferred, the plant is a palm tree.

Also within the invention is a device for securing a plant, comprising a flexible material having a first surface and a second surface, wherein the first and the second surfaces have a common first edge, a second edge, a third edge and a fourth edge, each of the edges has a length measured along the largest dimension of the edge, the length of the first edge is greater than the length of the second edge, and the third and fourth edges extend between the first edge and the second edge; and a detachable fastening mechanism for fastening the device when the device is wrapped around a plant by bringing the third and fourth edges adjacent to one other, wherein the fastening mechanism comprises a first Velcro strip positioned in a longitudinally extending direction along the first surface of the flexible material adjacent the third edge of the flexible material and at least one flexible strip secured to the first surface of the flexible material adjacent the fourth edge of the flexible material and extending outwardly in a transverse direction from the fourth edge of the flexible material, wherein the flexible strip has a second Velcro strip capable of mating with the first Velcro strip positioned on a first side of the flexible strip and facing in the direction of the second surface of the flexible material and wherein the flexible material is configured for wrapping around a plant and fastening with the fastening mechanism in order to hold and reinforce the plant.

The invention also includes a method for protecting a structure from wind damage, comprising positioning a device comprising a flexible material and having a first upper edge, a second lower edge and two side edges adjacent a structure having a central longitudinal portion and radially extending arms, such that the second lower edge of the flexible material is positioned near a lower portion of the radially extending arms; wrapping the flexible material around the radially extending arms such that the arms are pushed toward the central longitudinal portion of the structure until the two side edges of the flexible material are proximate one another; and fastening the flexible material in place around the structure, wherein the flexible material is configured to secure the radially extending arms against the central longitudinal portion of the structure and to reinforce the central longitudinal portion of the structure.

In one embodiment of the method, the first upper edge and the second lower edge have an arcuate configuration and the first upper edge has a length which is larger than the second lower edge such that when the flexible material is fastened around the structure it has a generally frustoconical configuration.

In yet a further embodiment of the method, the flexible material is fastened in place around the structure by contacting two mating Velcro strips and/or the structure is a plant, and more preferably a palm tree.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings: FIG. 1 is a front view of a protective device according to one embodiment; FIG. 2 is a rear view of the device of FIG. 1; FIG. 3 is a view of the device as it is being applied to the palm tree; FIG. 4 is a view of the device as it is wrapped around (encircling the palm):

FIG. 1 is a front elevational view of an embodiment of a device as described herein;

FIG. 2 is a back elevational view of the embodiment of FIG. 1;

FIG. 3 is a front elevational view of the embodiment of FIG. 1 being positioned to wrap around a structure; and

FIG. 4 is a front elevational view of the embodiment of FIG. 1 fastened around a structure for securing and reinforcing the structure.

### DETAILED DESCRIPTION OF THE INVENTION

The device as described herein is made of a flexible material, such as canvas, reinforced canvas-like fabric or a polymeric fabric having a configuration, which allows it to be wrapped around and preferably to encircle a longitudinally extending central portion of a structure having radially extending arms. It is particularly useful for plants of a variety of types that are vulnerable to wind damage, such as in a tropical storm, hurricane, monsoon, typhoon or similar storm carrying high winds. As described herein, the device will be described with respect to it ability to protect a palm tree, which trees are particularly expensive to replace and are vulnerable to harm and breakage where new branches/fronds may grow due to strong wind damage. The device is able to be positioned and wrapped around the longitudinal central portion of the structure—in this case, the trunk of a palm tree at the point where the lower fronds grow. It can then be secured in place and encircle the palm tree so as to push the lower fronds together and upward, thereby encircling and protecting the inner growth core of the trunk. The device can be made as a one-piece device such that it is easy to manufacture and inexpensive rendering it a simple and desirable way to protect such structures.

While the present invention will be described herein with respect to a palm tree for convenience, it will be understood based on this disclosure that the structures for which the device may be used to secure and reinforce such structures are not so limited. The device is preferred for use for any structure having a more longitudinally extending configuration that is vulnerable to wind damage. It is more preferably used with longitudinally extending structures having radially extending appendages or arms, such as signs, light poles, umbrellas and many varieties of plants having a central upright stem or trunk and branches, fronds, stems and the like which extend radially from the central longitudinal portion of the structure.

By wrapping the radially extending arms such as branches, fronds and the like around a central longitudinal portion of a structure, the structure is protected, reinforced and secured. In the case of a plant, such as a palm tree, the device can be located so as to protect an area of the plant where the branches or fronds are extending from points of growth along the central longitudinal portion or trunk. With respect to a palm tree, the device can be placed around the area where the palm fronds extend from the trunk at the single inner growth core, thereby protecting the inner growth core from breakage enabling the tree to survive winds, including high winds along the lines of hurricane force winds.

The device is able to be wrapped around the longitudinal portion of a structure such as a trunk of a palm tree to encircle it at the site where the palm fronds sprout the tree, causing lower fronds to be wrapped around the tree in a cone-like manner. The device encircles the lower portion of the lower fronds and forms a wall of fronds around the tree's inner growth core at the top portion of the trunk that reinforces the inner core and protects it from breakage in the face of high winds.

The device includes a flexible material and can be made in a wide variety of sizes, depending to a large degree on the intended structure it will reinforce, and while not necessary, preferably has an arc-like configuration along the top and bottom edges that allows the device to more easily wrap around and encircle a structure such as the trunk of a palm tree (or similar shrub or plant) at the site on the trunk where the lower fronds have grown. This will thereby lift the lower fronds and create a protective sheath of fronds that surround and reinforce the inner growth core of the palm tree and protect it from breakage in the face of high winds. This same principle can apply to other structures requiring reinforcement or support at points of vulnerability and breakage when subjected to wind forces.

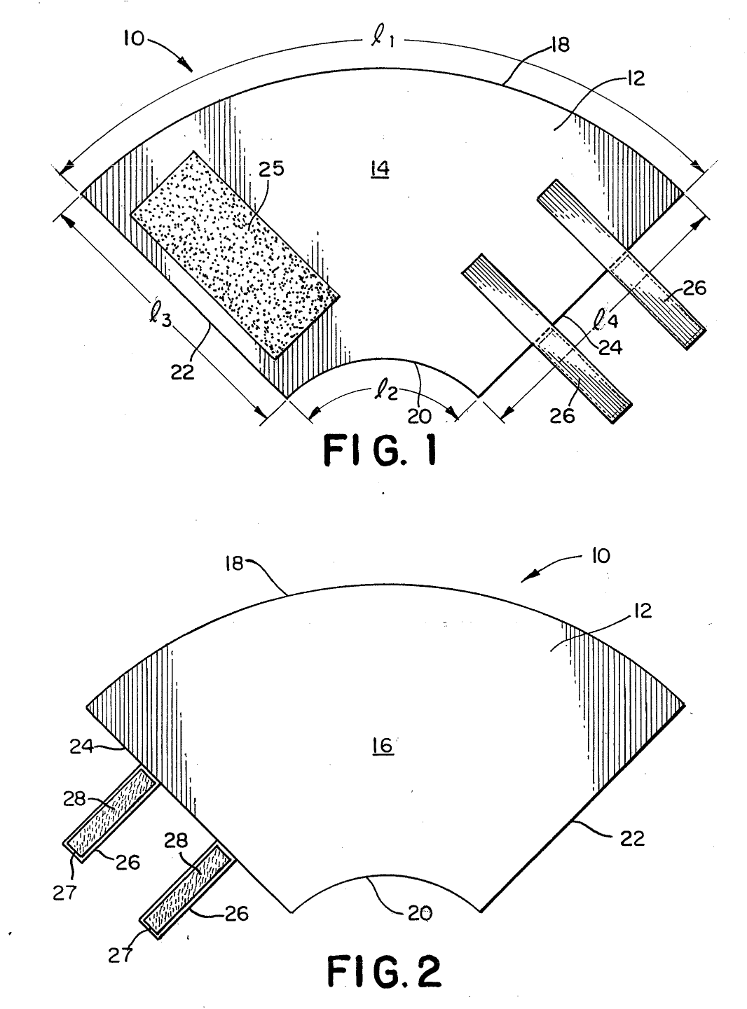

The device will now be described in accordance with the drawings and with respect to a non-limiting and preferred embodiment in use to reinforce and support a palm tree for protection in wind forces, including high winds such as hurricane force winds. The device as shown in FIGS. 1-4 is referred to generally herein as device 10. The device 10 includes a flexible material 12. The flexible material 12 may be any suitable fabric having some flexibility, but providing sufficient structural support for the intended use. For example, suitable flexible materials include fabrics, reasonably strong elastomeric materials, metallic or polymeric sheeting, and woven and non-woven polymeric fabrics. Fabrics may be synthetic or natural in derivation or be blends thereof. Preferred fabrics include canvas and other canvas like tarp-like fabrics. The fabrics may also include protective coatings or backing for prevention of tearing and/or waterproofing and the like. Metallic sheeting, such as aluminum, thin sheet steel and the like are also acceptable. Thick elastomer or polymer sheeting is also acceptable, but is preferably reinforced, as in a molded composite polyolefin sheeting. Polymeric fabrics such as fluoropolymeric fabrics (such as Goretex®), and other strengthened polymeric fabrics (such as Tyvek® and Kevlar®) and the like as well as reinforced and nonreinforced synthetic materials and nonwovens may also be used. Other preferred polymeric fabrics include polyolefins, polycarbonates, polyamides and polyarylene ketones and blends, copolymers and alloys of these materials. Such fabrics are preferably reinforced so as to provide sufficient strength for the intended purpose, including use of reinforcing fibers and/or particles, such as carbon, graphite, glass, Kevlar®, aramid fiber and the like. Preferably, for cost purposes and strength, a coated canvas or can may be reinforced and/or composite materials. It is preferred to use a canvas or other fabric, and to try to keep weight down for ease of use and flexibility combined with adequate strength properties, with the goal that the device would have a weight manageable for use by only a single person.

The flexible material 10 has two opposing surfaces, a first surface 14 and a second surface 16. With reference to the first surface as shown in FIG. 1, the flexible material has for edges. A first upper edge 18, a second lower edge 20, and third and fourth edges 22, 24. Each of the edges has a length l₁, l₂, l₃ and l₄ measured along the largest dimension of the edge. In the case of edges 18, 20, as shown in FIG. 1, the edges are in a preferred arcuate configuration and so their respective lengths l₁, l₂ are measured arcuately along the edge whereas the edges 22, 24 are substantially straight and extend between edges 18, 20 such that their respective lengths l₃, l₄ are measured laterally along the straight edges.

The length l₁ of the first edge 18 is preferably greater than the length l₂ of the second edge 20, so that the third and fourth edges 22, 24 which extend between the first edge and the second edge taper inwardly toward edge 20.

As shown in FIG. 2, a second surface 16 having the same configuration as the first surface 14 preferably shares common edges 18, 20, 22, 24.

While not necessary, it is preferred that the third edge 22 and the fourth edge 24 are substantially the same length, and most preferably that they are the same length to avoid loose edges. The lengths of the edges of the device will vary in accordance with the structure to be secured by the device. For example, when securing palm fronds on a palm tree, the device may be made larger or smaller depending on the type of tree and the device could be made for manufacture in variety of sizes. Similarly while the flexible material is shown as one piece, it is within the scope of the invention that it could be made of multiple pieces of flexible material that snap or are otherwise joined together to give a variety of sizes of the device within one commercial unit. Preferably, the device has a unitary flexible material having a length along its lateral sides, or the third and fourth sides 22, 24 shown in FIGS. 1 and 2 of about 18 inches to about 36 inches. While the first and second edges are preferred to have a generally arcuate configuration as shown in FIGS. 1 and 2 for ease in wrapping, it is within the scope of the invention that the edges 18, 20 are straight and more laterally extending. It is preferred that the first edge is longer than the second edge to provide a tapered configuration as shown in FIG. 1, and further it is more preferred that the length l₁ of the first edge 18 is about 36 inches to about 72 inches, while the length l₂ of the second edge 20 is about 12 to about 24 inches.

When the device 10 is wrapped around a structure using the preferred configuration described herein it has a generally cylindrical, tapered cylindrical and/or frustoconical configuration in side view. The particular size and configuration is preferably also determined by the size of the palm tree or other structure to be protected.

The device 10 has a detachable fastening mechanism for fastening the device when the device is wrapped around a structure by bringing the third and fourth edges 22, 24 together adjacent to one other. It is not necessary that the edges be merely touching or overlapping when wrapped around a structure, and either is acceptable. However, it is preferred that for waterproofing and wind resistance that the edges overlap when the device 10 is wrapped around a structure. The fastening mechanism should be suitable to hold the device in place securely when the flexible material wrapping around a structure and fastened in order to hold and reinforce the structure. The fastening mechanism may be any suitable apparatus, including belts, hook and eye structures, snaps, D-buckles and straps, adjustable buckles of various designs, zippers, buttons or mating looped fabric closures, such as a Velcro® closure. Most preferably, for cost and ease of use, the fastening mechanism includes a mating Velcro® closure.

The fastening mechanism preferably comprises a first Velcro® strip 25 positioned in a longitudinally extending direction along the first surface 14 of the flexible material 12 adjacent the third edge 25 of the flexible material 12. This strip 25 would have fabric loops designed to mate with opposing Velcro® loops located on at least one flexible strip 26 secured to the first surface 14 of the flexible material 12 adjacent the fourth edge 24 of the flexible material 12. The Velcro® strip 25 is preferably securely attached and integral to the flexible material 12 such as by sewing and the like, and similarly the mating Velcro® piece located on the flexible strip(s) 26 is/are similarly attached. It is preferred, but not necessary, that the flexible strips 26 are made of the same fabric as the flexible material 12, but they may also be elastomeric or of a nylon netting and the like depending on the desired properties for closure.

It should be understood from this disclosure that the number of strips 26, can vary from one to several or be simply one long strip similar to strip 25. Preferably, the strips 26 extend outwardly from the flexible fabric 12 in a transverse direction from the fourth edge 24 of the flexible material 12. The flexible strip 26 can be formed of fabric and have thereon the second, mating Velcro® surface or strip sewn or otherwise attached thereto which is capable of mating with the first Velcro® strip 25. The Velcro® on strip(s) 26 is preferably positioned on a first side 27 of the flexible strip(s) 26 which side 27 faces in the direction of the second surface 16 of the flexible material 12.

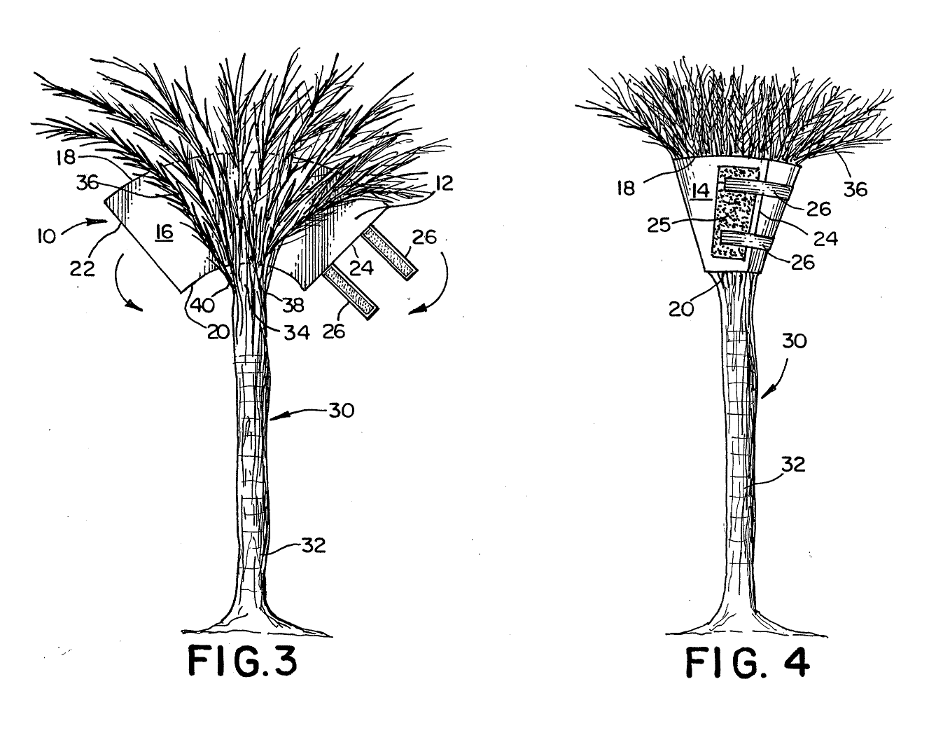

A method for protecting a structure from wind damage is also described herein and preferably is practiced in accordance with the device 10 as described above. The method includes positioning a device, such as device 10, having a flexible material, such as material 12, and having a first upper edge 18, a second lower edge 20 and two side edges 22, 24 adjacent a structure. For the purposes of describing the method and use of device 10 in operation, reference is made to FIGS. 3 and 4, wherein a palm tree, generally referred to as 30, is used to describe a preferred, but not limiting embodiment. As shown, a central longitudinal portion, in this case a trunk 32 of a palm tree 30 and having radially extending arms, in this case branches 36 is covered by a wrapping of flexible material 12 using device 10. The second lower edge 20 is preferably positioned such that it is near to the lower portion 34 where the radially extending arms/branches 36 form out of the trunk 32.

The flexible material is then wrapped around the bottom portion of the radially extending arms or branches 32 such that the branches are pushed toward the central longitudinal portion or trunk 32 of the tree 30 and until the two side edges 22, 24 of the flexible material 12 are proximate one another. As noted above, the edges may be touching, separated or overlapping, but are preferably slightly overlapping for best securing the structure.

The flexible material is then fastened in place around the tree 30, such that the flexible material, which is configured to secure the radially extending arms/branches against the central longitudinal portion/trunk of the structure/tree and to reinforce the central longitudinal portion of the structure is securely in place. The first upper edge 18 and the second lower edge 20 are preferably arcuate such that the first upper edge has a length which is larger than the second [symbol] and so that when the flexible material 12 is fastened around the structure it has a generally cylindrical, tapered and/or frustoconical configuration.

The flexible material is preferably fastened in place using mating Velcro strips as described hereinabove. Once in place, the growth core 34 of the tree 30 is protected by the branches/fronds 36 as they wrap closely near the trunk 32 in the area of the growth core 34 providing protection to the trunk 32 in the area of the growth core 34 against breakage and securing the tree for future growth of new branches after diminishment of wind force.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-15. (canceled)

16. A method for protecting a structure from wind damage, comprising
positioning a device comprising a flexible material and having a first upper edge, a second lower edge and two side edges adjacent a structure having a central longitudinal portion and radially extending arms, such that the second lower edge of the flexible material is positioned near a lower portion of the radially extending arms;
wrapping the flexible material around the radially extending arms such that the arms are pushed toward the central longitudinal portion of the structure until the two side edges of the flexible material are proximate one another; and
fastening the flexible material in place around the structure, wherein the flexible material is configured to secure the radially extending arms against the central longitudinal portion of the structure and to reinforce the central longitudinal portion of the structure.

17. The method according to claim 16, wherein the first upper edge and the second lower edge have an arcuate configuration and the first upper edge has a length which is larger than the second lower edge such that when the flexible material is fastened around the structure it has a generally frustoconical configuration.

18. The method according to claim 16, wherein the flexible material is fastened in place around the structure by contacting two mating looped fabric fastener strips.

19. The method according to claim 16, wherein the structure is a plant.

20. The method according to claim 19, wherein the plant is a palm tree.

21. The method according to claim 20, wherein the radially extending arms are branches of the palm tree and the lower portion of the radially extending arms is a growth core of the palm tree, the method further comprising fastening the flexible material in place around the palm tree such that the flexible material wraps the branches around the central longitudinal portion of palm tree and the device reinforces the growth core of the palm tree.

22. The method according to claim 16, wherein the flexible material comprises a detachable fastening mechanism comprising a first looped fabric fastener strip positioned along a first surface of the flexible material adjacent a side edge of the flexible material and a flexible strip secured to the first surface of the flexible material adjacent the other side edge of the flexible material, wherein the flexible strip has a second looped fabric fastener strip capable of mating with the first looped fabric fastener strip, and the method further comprises fastening the flexible materials by attaching the first and second looped fabric fastener strips after the flexible material is positioned in place around the structure.

23. The method according to claim 16, wherein the flexible material comprises canvas, a polymeric woven fabric and/or a polymeric unwoven fabric.

24. The method according to claim 23, wherein the flexible material is a fluoropolymer fabric.

25. A method for protecting a plant from wind damage, comprising
positioning a device comprising a flexible material and having a first upper edge, a second lower edge and two side edges, and a detachable fastening mechanism adjacent the plant, wherein the plant has a longitudinal portion, radially extending branches and a growth core on the longitudinal portion of the plant positioned at about the location where the radially extending branches extend from the longitudinal portion of the plant, such that the second lower edge of the flexible material is positioned just below the growth core;
wrapping the flexible material around the branches such that the branches are pushed toward the central longitudinal portion of the plant and wrap around the growth core and the two side edges of the flexible material are proximate one another; and
fastening the fastening mechanism of the flexible material and tightening it so that the branches remain wrapped around the growth core and the flexible material and branches reinforce the growth core.

26. The method of claim 25, wherein the plant is a palm tree.

27. The method according to claim 25, wherein the detachable fastening mechanism comprises a first looped fabric fastener strip positioned along a first surface of the flexible material adjacent a side edge of the flexible material and a flexible strip secured to the first surface of the flexible material adjacent the other side edge of the flexible material, wherein the flexible strip has a second looped fabric fastener strip capable of mating with the first looped fabric fastener strip, and the method further comprises fastening the flexible materials by attaching the first and second looped fabric fastener strips after the flexible material is positioned in place around the structure.

28. The method according to claim 25, wherein the flexible material comprises canvas, a polymeric woven fabric and/or a polymeric unwoven fabric.

29. The method according to claim 25, wherein the flexible material is a fluoropolymer fabric.
